(19) United States
(12) Patent Application Publication
(10) Pub. No.: US 2010/0198376 A1
(43) Pub. Date: Aug. 5, 2010

(54) PERSONAL AUDIO DEVICE

(75) Inventors: David MacKenzie, Poway, CA (US); Peter Shintani, San Diego, CA (US); Toshiyuki Suzuki, San Diego, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Tokyo (JP); SONY ELECTRONICS, INC., Parkridge, NJ (US)

(21) Appl. No.: 12/366,432

(22) Filed: Feb. 5, 2009

(51) Int. Cl. G06F 17/00; G05B 19/02

(52) U.S. Cl. 700/94; 340/825.24

(57) ABSTRACT

A system for providing localized audio content from a remote control device. Embodiments of the present invention utilize the proximity of the remote control device to provide audio content directly to a user without disturbing others. The complexity of normal subwoofer setup is eliminated as subwoofer audio channel is wirelessly delivered to the remote control device and rendered there. Embodiments further include the necessary signal processing circuitry to generate audio channels and send the signal wirelessly for playback in proximity to user.

### FIELD OF THE INVENTION

Embodiments of the present invention are generally related to communication devices and systems such as remote control devices, e.g., for remote control of electronic devices.

### BACKGROUND OF THE INVENTION

As technology advances, home entertainment systems and display devices such as televisions have become increasingly widespread. Unfortunately, those enjoying content may disturb others in the area. For example, those hard of hearing may need to have the volume louder to compensate, while others may be easily disturbed while sleeping. The sound of content may also flow through walls and floors disturbing those in other rooms.

One attempt to solve these problems is to have the user purchase a mechanical transducer and wire it to the subwoofer output of an audio/video (AV) amplifier. This requires the user to figure out to setup the transducer and connect the transducer correctly. Further, if the transducer is located on a wall or on the floor, the advantage over an acoustical subwoofer is eliminated as others may be disturbed.

### SUMMARY OF THE INVENTION

Thus, a need exists for a device that can provide localized audio output with minimal disruption of those around the user. Embodiments of the present invention include remote control devices and other devices with audio components (e.g., speaker, transducer, etc.) for outputting audio in close proximity to the user. Embodiments further conserve power by selectively turning off audio components when not in use (e.g., no audio signals, mute, etc.).

In one embodiment, the present invention is implemented as a system for use as a personal audio device (e.g., remote control device, etc). The system includes a power module for powering the personal audio device and a control command transmission module operable to receive input commands and issue the commands to a device to be controlled (e.g., display device, audio system, etc.). The system further includes a receiver (e.g., RF receiver) operable to wirelessly receive audio signals and an audio component including a transducer operable to be used for outputting an audio channel of the audio signal (e.g., a bass audio channel).

In another embodiment, the present invention is implemented as a system for performing remote control and having an audio output capability. The system includes an input module for receiving commands to be communicated and a transmission module for transmitting the commands. The system further includes a receiver for receiving audio signals and an audio component for outputting the audio signal. The audio component may include a speaker. The speaker may be designed for use in a remote control device and for providing audio in close proximity to a user.

In this fashion, embodiments of the present invention implement a system for providing localized audio content. More specifically, embodiments of the present invention utilize the proximity of a remote control device to provide audio content without disturbing others. In one embodiment, the complexity of normal subwoofer setup is eliminated as subwoofer audio channels are wirelessly delivered to the remote control device. Embodiments further include the necessary signal processing circuitry to generate audio channels and send the signal wireless for playback in proximity to user.

In another embodiment, the present invention is implemented as a remote control device. The remote control device includes an input module for receiving a command to be transmitted and a transmitter for transmitting the command received by the input module. The remote control device further includes a radio frequency receiver for receiving an audio signal and an audio component for facilitating output of the audio signal. The audio component is further operable to be coupled to an audio output device (e.g., headphones, external speakers, etc.).

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary operating environment in accordance with one embodiment of the present invention.

FIG. 2 shows an exemplary system for providing remote control signals in accordance with one embodiment of the present invention.

FIG. 3 shows an exemplary electronic device operable to be remotely controlled in accordance with one embodiment of the present invention.

FIG. 4 shows an exemplary system for providing remote control signals in accordance with one embodiment of the present invention.

FIG. 5 shows another exemplary operating environment in accordance with one embodiment of the present invention.

FIG. 6 shows a block diagram of an exemplary system for outputting an audio signal in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

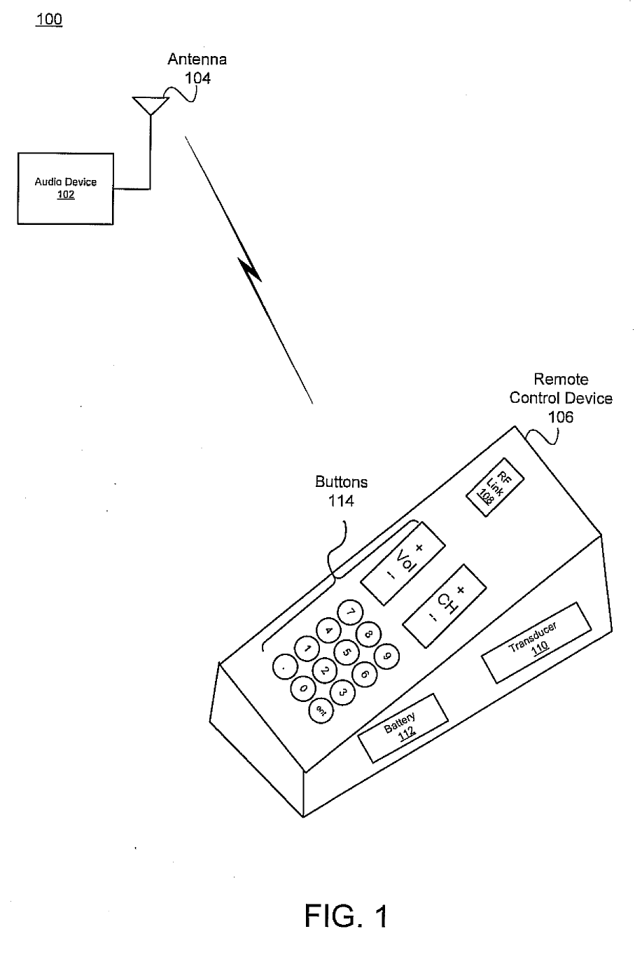

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

FIGS. 1-4 illustrate example components used by various embodiments of the present invention. Although specific components are disclosed in systems 100, 200, 300, and 400 it should be appreciated that such components are examples. That is, embodiments of the present invention are well suited to having various other components or variations of the components recited in 100, 200, 300, and 400. It is appreciated that the components in 100, 200, 300, and 400 may operate with other components other than those presented, and that not all of the components of 100, 200, 300, and 400 may be required to achieve the goals of systems 100, 200, 300, and 400.

FIG. 1 shows an exemplary operating environment in accordance with one embodiment of the present invention. Operating environment 100 includes audio device 102 and exemplary remote control device 106. Audio device 102 includes antenna 104 for wirelessly transmitting audio signals and receiving control signals. Exemplary remote control device 106 includes radio frequency (RF) link 108, transducer 110, battery 112, and buttons 114. RF link 108 is operable to receive audio signals from audio device 102 and transmit commands received via buttons 114. Buttons 114 allow user input of commands for transmission to audio device 102 and/or other devices operable to be controlled. RF link 108 provides the received audio signals to transducer 110 for output to a user, as described herein. Battery 112 provides power to remote control device 106.

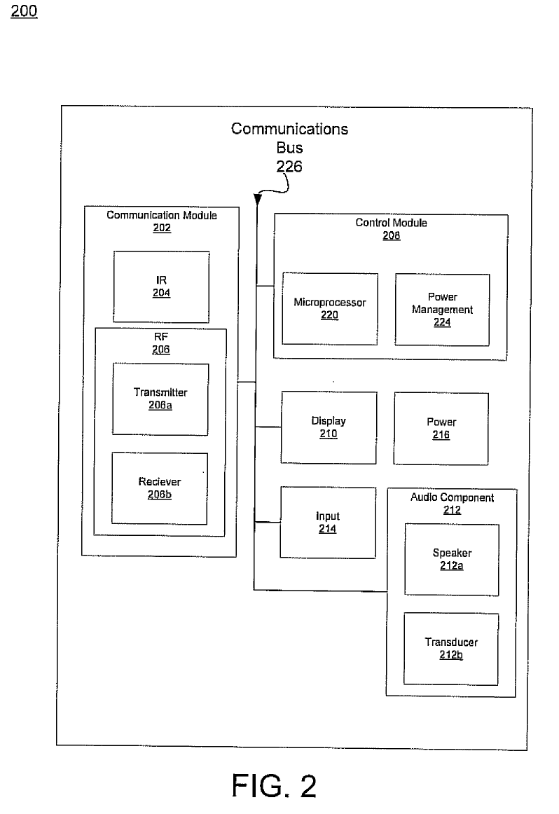

FIG. 2 shows an exemplary system for providing remote control signals in accordance with one embodiment of the present invention. System 200 may be a system for use as a personal audio device, system for performing remote control, or a remote control device. System 200 includes communication module 202, control module 208, optional display 210, audio component 212, input module 214, power source 216, and communication bus 226. Communications bus 226 facilitates communication between the components of system 200 including, but not limited to, communications module 202, control module 208, display 210, audio component 212, and input module 214.

Input module 214 allows entry of commands into system 200 which may then be used to control a device (e.g., system 300). Input module 214 may include, but is not limited to, navigations pads, keyboards (e.g., QWERTY), up/down button, touch screen control (e.g., via display 210) and the like.

Communication module 202 is operable to communicate control signals to a device (e.g., system 200). In one embodiment, command communication module 202 includes infrared (IR) transmitter 204 and radio frequency (RF) module 206. RF module 206 includes transmitter 206a and receiver 206b. IR transmitter 204 and transmitter 206a are operable to transmit commands received via input module 214 to a device to be controlled (e.g., system 300). Communication module 202 may further receive signals (e.g., via receiver 206b) from a device to be controlled (e.g., system 200).

It is appreciated that communication module 202 may include a radio frequency transceiver. It is further appreciated that embodiments of the present invention may use a variety of wireless communication formats or protocols including, but not limited to, Industrial, Scientific, and Medical radio band (ISM) (e.g., 900 Mhz, 2.4 GHz, etc.), 802.11a/b/g/n, Bluetooth, Z wave, or other wireless standards or protocols. It is also appreciated that modulation can be analog or digital in nature.

Receiver 206b may receive audio signals including, but not limited to, monaural, stereo, or bass (e.g., low frequency) audio channels. Receiver 206b may further receive commands from the audio source (e.g., television or other A/V equipment) for adjusting output of audio component 212. The commands received by receiver 206b can be used to turn on and off receiver 206b. For example, if the user invokes a mute function, receiver 206b may receive a command to deactivate speaker 212a and/or transducer 212b to conserve power. As another example, where audio component 212 includes a transducer 212b, if the user turns off bass (e.g., low frequency) audio channels, receiver 206b may receive a command to deactivate transducer 212b until bass audio channels are turned back on. It is appreciated that commands and audio signals may also be received via an IR receiver (not shown).

Control module 208 may handle signals received by communication module 202. Control module 208 includes microprocessor 220 and power management module 224. Microprocessor 220 is used to process audio signals received via communication module 202 and further to perform any commands received via communication module 202 (e.g., commands from system 200, display device, audio system, etc.). Audio signals received via communication module 202 are sent to audio component 212 for output. It is appreciated that microprocessor 220 may send processed or unprocessed audio signals to audio component 212.

Power management component 224 is operable to control, among other things, receiver 206b and audio component 212. In one embodiment, when no audio signal being transmitted from the audio source (e.g., television, etc.), power management component 224 can direct receiver 206b can enter a sleep or low power mode where receiver 206b periodically wakes or activates to check for transmission of audio signals. If audio signals are detected, receiver 206b wakes up and transmits the audio signals to audio component 212 for output.

Power management module 224 (and/or microprocessor 220) may alter the operation of audio component 212. For example, the volume level of the output (e.g., of speaker 212a) may be reduced to save power. Similarly, the output of transducer 212b may be reduced to conserve power. In one exemplary embodiment, the modification of the operation of audio component 212 may be based on a length (e.g., 3 hours) or type of content (e.g., action film) received from a content source device (e.g., system 300). In another exemplary embodiment, power management module 224 may modify the operation of audio component 212 based on the amount of power remaining on power source 216. For example, as the battery gets low the operation of audio component 212 may be modified to conserve the remaining power.

It is appreciated that microprocessor 220 or power management module 224 may monitor input command received from input module 214 and power down receiver 206b and/or audio component 212. For example, if the user presses the mute button receiver 206b and/or audio component 212b can be deactivated until the user changes the volume or turns off mute.

In one exemplary embodiment, circuitry of speaker 212a and transducer 212b includes an automatic power down mode to power down in the event that there is no RF signal or if there were no significant amount of audio signal. It is appreciated that the low frequency sound frequently is not continuous in a program (e.g., corresponding to special effects and action sequences) thereby allowing portions of audio component 212 to be turned off frequently during a program.

Audio component 212 outputs sound from system 200. In one embodiment, audio component 212 includes speaker 212a. Speaker 212a may be a small speaker designed for system 200 to provide audio output within close proximity or the personal space of a user. In another embodiment, audio component is further operable to be coupled to an audio output device (e.g., headphones).

In another embodiment, audio component 212 includes transducer 212b. Transducer 212b may be a mechanical transducer operable to output low frequency or bass audio channel signals. The transducer 212b can be customized to fit into a remote control unit and act as a subwoofer. The close proximity (e.g., in bed, chair, couch, etc.) allows a user to use transducer 212b in place of an acoustical subwoofer and/or a larger external mechanical transducer. It is appreciated that while placing a transducer in a remote limits the power available, both the proximity and corresponding size provide sufficient tactile response to allow the user to feel the bass while the remote control device is near the user (e.g., at the user's side in the bed or even a chair).

The close proximity of transducer 212b allows a user to receive audio content without distributing others (e.g. the remote control device could be under pillow or beside the user's head). For example, when the user is in bed with a sleeping person near, the small vibrations of the transducer allow the user to have a full media content experience with little to no disruption of the sleeping person. Transducer 212b allows vibrating a pillow, hand, edge of derriere, without disturbing others. Transducer 212b thus emulates a subwoofer inside system 200 thereby allowing the user to experience low frequency audio within the user's personal space.

Power source 216 provides power for system 200. Power source 216 may be portable power source including, but not limited to, disposable batteries (e.g., alkaline), rechargeable batteries (e.g., lithium ion, nickel metal hydride, nickel-cadmium, etc.). Power source 216 may facilitate system 200 to be placed on a charger when not in use (e.g., electrically or magnetically coupled) or plugged in. In one embodiment, system 200 may have space for both rechargeable and disposable batteries.

In this fashion, embodiments of the present invention implement a system for providing localized audio content. More specifically, embodiments of the present invention utilize the proximity of a remote control device to provide audio content without disturbing others. In one embodiment, the complexity of normal subwoofer setup is eliminated as subwoofer audio channels are wirelessly delivered to the remote control device. Embodiments further include the necessary signal processing circuitry to generate audio channels and send the signal wireless for playback in proximity to user.

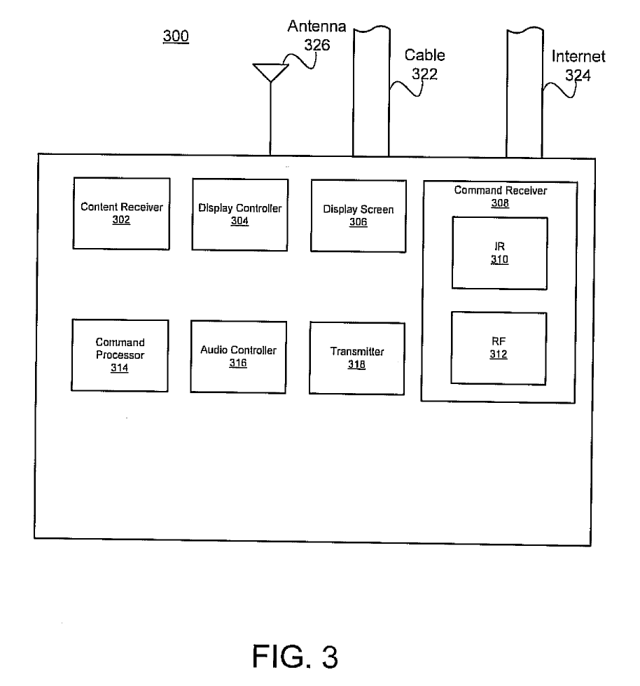

FIG. 3 shows an exemplary device operable to be remotely controlled in accordance with one embodiment of the present invention. It is appreciated that embodiments of system 300 include a variety of electronic devices that can be controlled remotely, including but not limited to computers, display devices, televisions, cathode ray tube (CRT) displays, computer monitors, liquid crystal displays (LCDs), plasma displays, projection displays, projectors, portable devices, game consoles, handheld devices, audio systems, compact disc (CD) players, digital versatile disc (DVD) players, digital audio players, and audio/video receivers, etc. System 300 includes content receiver 302, display controller 304, display screen 306, command receiver 308, command processor 314, audio controller 316, transmitter 318, cable or satellite connection 322, internet connection 324, and wireless antenna 326.

Content receiver 302 receives content for system 300. Receiver 302 may receive signals including content from a variety of sources including, but not limited to, computers, computer networks, portable devices, set top boxes, over the air broadcasts, cable broadcasts, satellite broadcasts, Digital versatile Discs (DVDs), Blu-ray discs, Digital Video Broadcasting-Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), Internet Protocol Television (IPTV), audio devices, etc. Content receiver 302 may receive content (e.g., electronic programming guide information and other content) via cable or satellite connection 322, internet connection 324, and wireless antenna 326 (e.g., via 802.11a/b/g/n, Bluetooth, Z wave, Digital Broadcast, etc.).

Display controller 304 controls display screen 306 of system 300. Display controller 304 may control a variety of display screens associated with system 300, including but not limited to, CRTs, LCDs, plasma displays, projection based, and Digital Light Processing (DLP) displays.

Command receiver 308 receives commands. Command receiver 308 may receive commands via a variety of receivers including, but not limited to, infrared receiver and radio frequency receivers. The commands may have been issued via a remote control (e.g., system 300 of FIG. 2). In one embodiment, command receiver 308 includes an infrared (IR) receiver 310 and/or a radio frequency (RF) receiver 312.

Command processor 314 processes commands received by system 300 via command receiver 308. The commands received are processed and executed by system 300. For example, control codes (e.g., increase volume, change channel, launch an application, launch web browser, etc.) may be received by via an infrared receiver 310 or radio frequency receiver 312, decoded, and sent to the command processor 314.

Audio controller 316 controls audio output for system 300 including a variety of outputs including, but not limited to, 2, 2.1, 3.1, 5.1, 6.1, 7.1, and 8.1 channel audio. The audio content may be received via content receiver 302. It is appreciated that audio controller 316 may output to audio equipment integrated within system 300.

Transmitter 318 may send signals to a control device (e.g., remote control). The signals transmitted may be full or partial audio signals. The signals may include, but are not limited to, commands (e.g., indicating mute, volume to zero, bass output deactivation, etc.), and audio signals (e.g., monaural, stereo, bass or low frequencies audio channels, etc.).

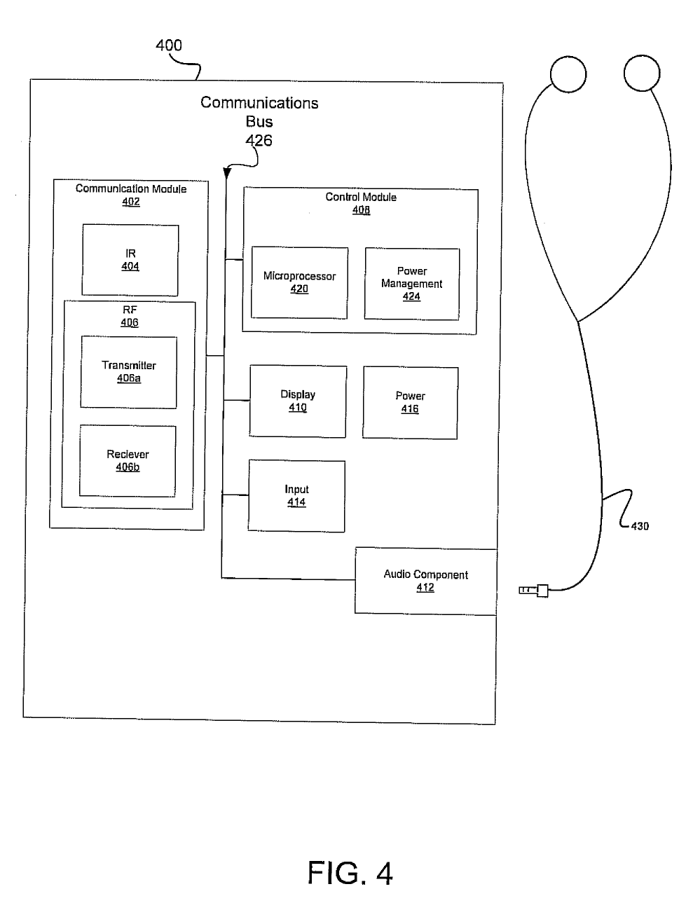

FIG. 4 shows an exemplary remote control device or system for providing remote control signals in accordance with one embodiment of the present invention. In one embodiment, system 400 operates in a substantially similar manner to system 100. Audio component 412 facilitates output of an audio signal and is operable to be coupled to an audio output device (e.g., headphones, speakers, headsets, etc.). In one embodiment, audio component 412 has a headphone jack for coupling headphones 430 to system 400. It is appreciated that headphones or other audio devices may allow for a higher fidelity user experience over a speaker within system 200. It is appreciated that system 400 may optionally include speaker (e.g., speaker 212a) and/or transducer (e.g., transducer 212b).

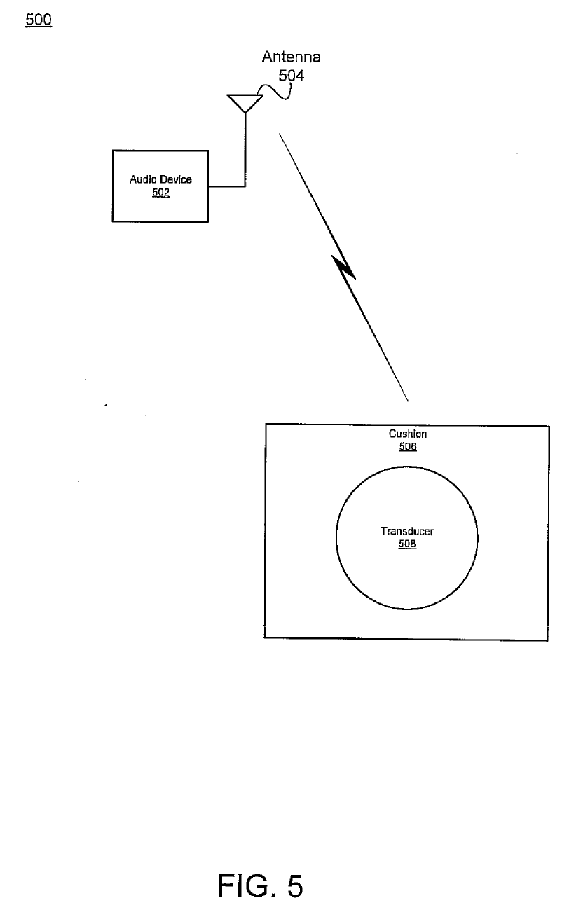

FIG. 5 shows another exemplary operating environment in accordance with one embodiment of the present invention. Operating environment 500 includes audio device 502 and cushion 506. Audio device 502 includes antenna 504. In one embodiment, antenna 504 facilitates wireless transmission of audio signals (e.g., bass audio channel signals). Cushion 506 includes transducer 508. Transducer 508 receives audio signals from audio device 502. Transducer 508 provides localized audio rendering as further described herein.

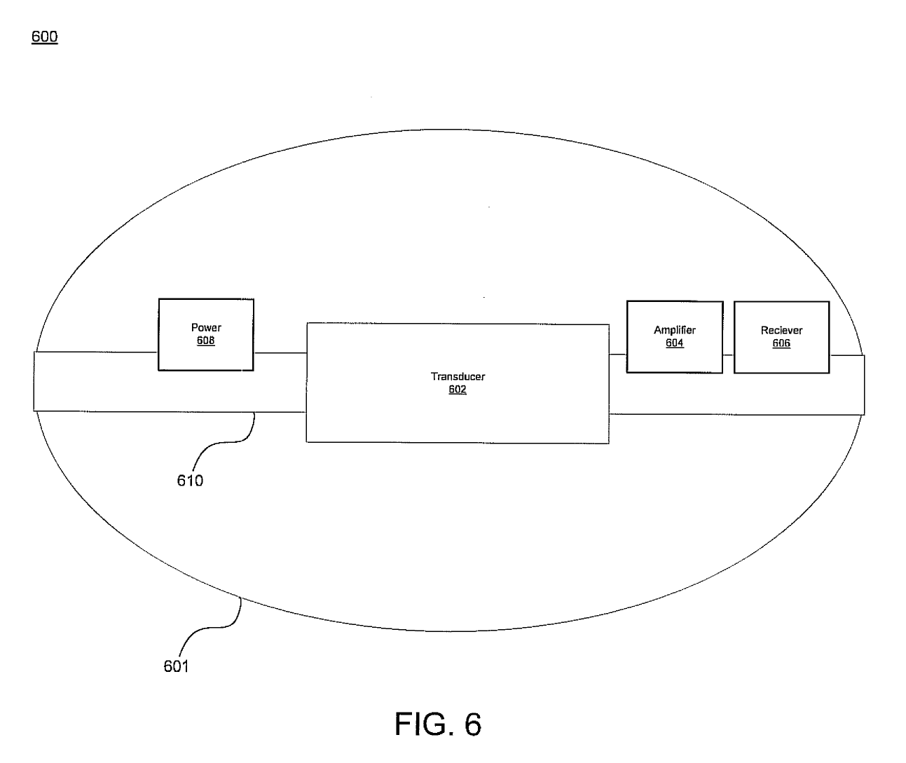

FIG. 6 shows a block diagram of an exemplary system for receiving and rendering an audio signal in accordance with one embodiment of the present invention. System 600 includes transducer 602, amplifier 604, receiver 606, power module 608, and support 610. System 600 may be an individual cushion which a user may place on a chair, couch, bed, or other furniture such that system 600 is in close proximity location to the user. System 600 may also be built into a chair, couch, or other piece of furniture. It is appreciated that system 600 may be used in place of a space consuming subwoofer.

Receiver 606 receives audio signals (e.g., bass or low frequency audio channel signals) from an audio device (e.g., system 300, etc.) and provides the signals to transducer 602 via amplifier 604. In one embodiment, amplifier 604 may be a high efficiency Class B or Class D amplifier. It is appreciated that receiver 606 may receive and process commands for conserving power as described herein. It is further appreciated that receiver 606 may perform power saving functions substantially similar to power management module 224.

Transducer 602 is coupled to support 610 for holding the relative position of transducer 602 in cushion 601 and for facilitating transducer 602 in providing vibrational output. Transducer 602 may output bass or low frequency audio channel signals. A user may thus merely turn system 600 on, and adjust the level of the subwoofer to their preferences via a display device (e.g., graphical user interface (GUI)) or A/V system. The transducer 602 may be designed such that it could easily be concealed in a typical cushion or a piece of furniture.

Power source 608 provides power for system 600. Power source 608 may be portable power source including, but not limited to, disposable batteries (e.g., alkaline), rechargeable batteries (e.g., lithium ion, nickel metal hydride, nickel-cadmium, etc.). Power source 608 may also facilitate coupling system 600 to a wall socket or other external electrical source.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system for use as a personal audio device comprising:
a power module for powering said personal audio device;
a control command transmission module operable to receive commands and issue commands to a device to be controlled;
a receiver operable to wirelessly receive an audio signal; and
an audio component comprising a transducer operable to be used for outputting an audio channel of said audio signal.

2. The system of claim 1 wherein said audio component further comprises a speaker.

3. The system of claim 2 wherein said audio signal comprises a monaural audio signal.

4. The system of claim 2 wherein said audio signal comprises a stereo audio signal.

5. The system of claim 2 wherein said audio signal comprises a bass audio signal.

6. The system of claim 1 wherein said receiver is a radio frequency (RF) receiver.

7. The system of claim 1 wherein said receiver is operable to receive a command for adjusting output of said audio component.

8. The system of claim 7 wherein said command is received from a display device.

9. The system of claim 7 wherein said command is received from an audio device.

10. The system of claim 1 wherein said audio component is further operable to be coupled to headphones.

11. A remote control device for performing remote control operations of a remote device, said remote control device comprising:
an input module for receiving commands to be communicated;
a transmission module for transmitting said commands;
a receiver for receiving audio signals; and
an audio component for outputting said audio signal, wherein said audio component comprises a speaker.

12. A remote control device as described in claim 11 wherein said receiver is operable to receive a command for adjusting output of said audio component.

13. A remote control device as described in claim 11 further comprises:
a power management component for controlling said receiver and audio component.

14. A remote control device as described in claim 13 wherein said power management component is operable to control said receiver and audio component based on a command received from via said receiver.

15. A remote control device as described in claim 13 wherein said power management component is operable to periodically activate said receiver.

16. A remote control device as described in claim 13 wherein said power management component is operable to alter the operation of said audio component.

17. A remote control device as described in claim 11 wherein said audio component comprises a transducer.

18. A remote control device comprising:
an input module for receiving a command to be transmitted;
a transmitter for transmitting said command received by said input module;
a radio frequency receiver for receiving an audio signal; and
an audio component for facilitating output of said audio signal and operable to be coupled to an audio output device.

19. A remote control device as described in claim 18 wherein said audio output device is headphones.

20. A remote control device as described in claim 18 wherein said radio frequency receiver is operable to receive a command for adjusting said audio component.
